(19) United States
(12) Patent Application Publication
(10) Pub. No.: US 2017/0086945 A1
(43) Pub. Date: Mar. 30, 2017

(54) PROCEDURES AND DEVICES FOR ENABLING A DENTAL TREATMENT ELEMENT TO BE APPLIED TO A DENTAL ARCH

(71) Applicant: LOREN S. ADELL, SUNNYVALE, TX (US)

(72) Inventor: LOREN S. ADELL, SUNNYVALE, TX (US)

(21) Appl. No.: 15/375,097

(22) Filed: Dec. 12, 2016

Related U.S. Application Data
(63) Continuation-in-part of application No. 13/200,004, filed on Sep. 14, 2011, now Pat. No. 9,526,591.

(51) Int. Cl. A61C 7/14; A61C 9/00

(52) U.S. Cl. CPC A61C 7/146; A61C 9/0006

(57) ABSTRACT

Procedures for bonding a dental treatment element, such as an orthodontic bracket, on a patient's tooth. A sheet assembly is used to fabricate an impression of at least a portion of a patient's dental arch while also capturing and holding a dental treatment device which is being releasably held on the patient's arch model. The sheet assembly has a sheet which is suitable for use in an intra-oral environment and is both formable and liquid-soluble. It also has at least one stiffener element disposed on the sheet's perimeter margin while leaving a central zone of the sheet uncovered.

### FIELD OF THE INVENTION

This invention relates to dentistry. In particular the invention relates to procedures and devices for enabling a dental treatment element to be applied to a dental arch.

### BACKGROUND OF THE INVENTION

Various procedures can be used for bonding a dental treatment element, such as an orthodontic bracket for example, to a tooth of a patient's dental arch. For example, an orthodontic bracket may simply be placed against a desired area of the labial or lingual surface of an individual tooth and bonded to the tooth. Proper location of an orthodontic bracket depends on the skill of the dentist or orthodontist. Properly locating and then bonding orthodontic brackets on a tooth-by-tooth basis may not be an efficient use of patient or orthodontist time.

A more efficient procedure involves first creating a model of the entirety or a portion of an individual's dental arch in any of various ways such as by taking an arch impression and then using the arch impression to create the model from any suitable material. Orthodontic brackets are then located at desired locations on and temporarily adhered to individual teeth of the model by a releasable material, such as wax or a weak adhesive. Next a material which is initially shapeable, but will eventually assume a shape for holding the brackets in the positions at which they have been temporarily adhered to the teeth, is applied over each bracket in a manner extending continuously from one bracket to the next. Silicone is an example of such a material. Once the material ceases to be shapeable, it and the brackets which it is holding in their desired positions are removed from the model. After any residual adhesive has been removed from the brackets, the resulting device is ready to be applied to the patient's arch.

When the device is first applied, it can be placed to verify correct position of the brackets. Once that has occurred, the brackets are bonded to the teeth using any suitable process which creates a sufficiently strong bond for the particular orthodontic objective to be achieved. After the brackets have been bonded, the material which has been holding them is removed.

Silicone can be pulled off, but the silicone may separate from portions which lodged in undercuts and/or grooves of orthodontic brackets. Removal of the residual silicone fragments is typically performed manually using a pick.

### SUMMARY OF THE INVENTION

Briefly, this disclosure introduces novel procedures and devices for enabling a dental treatment element to be applied to a person's dental arch.

In general the procedures comprise: creating a model of at least a portion of a patient's dental arch; releasably retaining a dental treatment element, such as an orthodontic bracket, at a desired surface location on the model via an interface which interfaces mutually confronting surfaces of the dental treatment element and the model; placing a sheet, which is both formable and liquid-soluble, in covering relation to a sufficient portion of the dental treatment element and a sufficient portion of the model to enable the sheet to be formed to a shape which dimensionally captures the dental treatment element and holds it in the position it has on the model; forming the sheet to a formed shape which dimensionally captures the dental treatment element and holds it in the position it has on the model; and separably fitting a support tray, which is releasable from the formed sheet, to the model in covering relation to at least a portion of the formed sheet.

The dental treatment element, the formed sheet, and the support tray are removed from the model and applied to a patient's dental arch to place the one of the mutually confronting surfaces belonging to the dental treatment element in confronting relation to a confronted surface of the patient's dental arch, and then bonding the one confronting surface belonging to the dental treatment element to the confronted surface of the patient's dental arch.

Then the support tray is removed from the formed sheet, and the formed sheet is dissolved by applying dissolving liquid to the formed sheet.

A disclosed embodiment of formed sheet comprises material which is water-soluble, such as a starch, for enabling the formed sheet to be dissolved by applying water to it.

The device which is used in the procedure which has just been described generally comprises a support tray shaped to fit to at least a portion of a patient's dental arch, and liquid-soluble material which is supported by the support tray and which captures and holds at least one dental treatment element in a location for enabling an exposed surface of the at least one dental treatment element to be applied to a patient's dental arch.

The foregoing summary, accompanied by further details of various embodiments of the procedures and devices, will be presented in the Detailed Description below with reference to the following drawings that are part of this disclosure.

### BRIEF DESCRIPTION OF THE DRAWINGS

FIG. 1 is an anterior view of a model of a person's upper dental arch.

FIG. 2 is a view of the dental arch model in the direction of arrows 2-2 in FIG. 1.

FIG. 3 is in the direction of arrows 3-3 in FIG. 1.

FIG. 4 is a view of FIG. 3 after orthodontic brackets have been placed on teeth of the dental arch model.

FIG. 5 is an enlarged lateral view of an orthodontic bracket which has been placed on a front tooth of the dental arch model.

FIG. 6 is a front elevation view illustrating a step of the disclosed procedure.

FIG. 7 is a view in the direction of arrows 7-7 in FIG. 6.

FIG. 8 illustrates a machine which performs the step of FIG. 6.

FIG. 9 is a lateral view of the dental arch model after the machine has performed the step of FIG. 6.

FIG. 10 is a lateral elevation view illustrating a further step of the disclosed procedure.

FIG. 11 is a perspective view illustrating by itself a support tray created by the step of FIG. 10.

FIG. 12 is a view like FIG. 7 but showing another embodiment.

FIG. 13 is a view in the direction of arrows 13-13 in FIG. 12.

### DETAILED DESCRIPTION

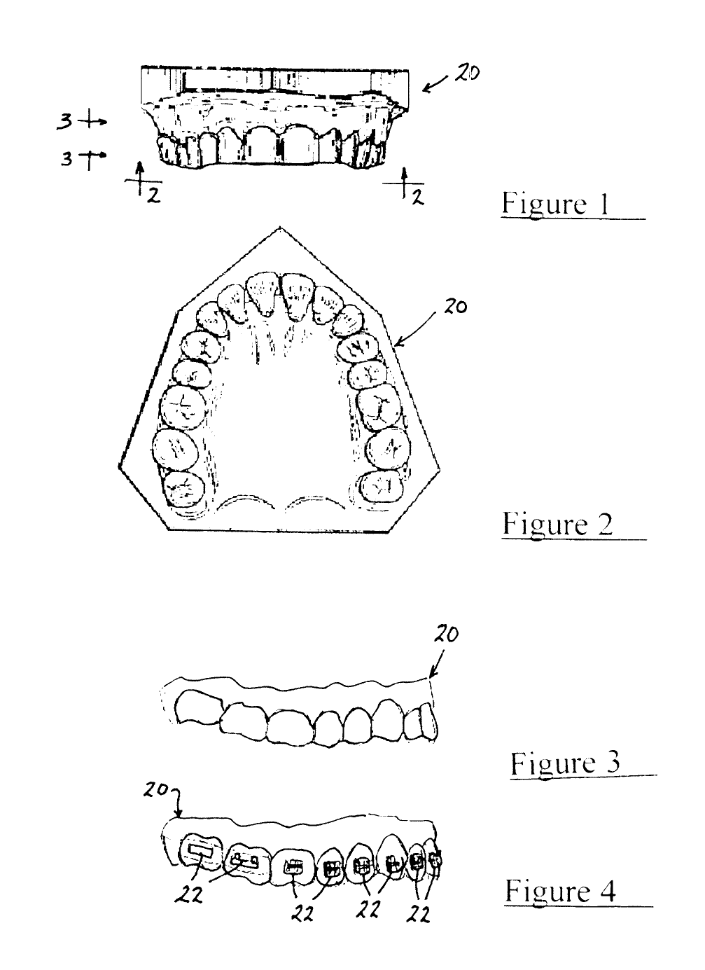

The disclosed procedures comprise creating a model of a patient's entire dental arch or a portion of the arch and then mounting at least one dental treatment element on the model. FIGS. 1, 2, and 3 show a model 20 of a person's entire upper dental arch.

FIG. 4 shows orthodontic brackets 22 releasably adhered to individual teeth of model 20.

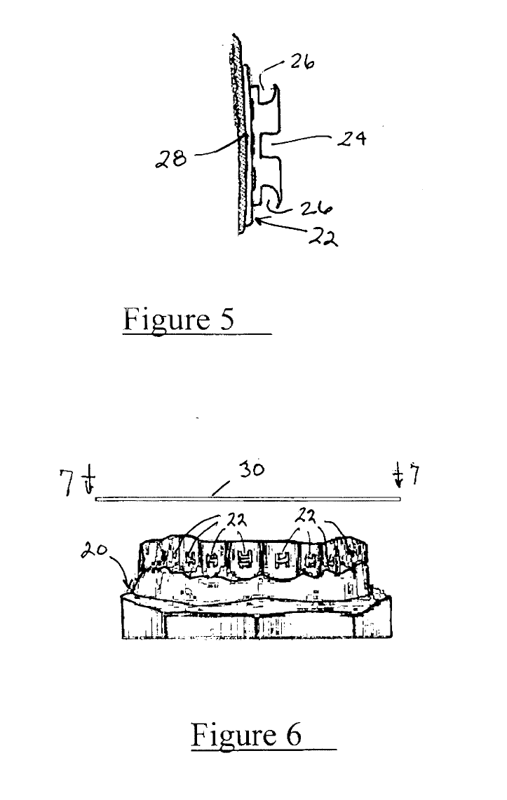

As shown in FIG. 5, a representative orthodontic bracket 22 has structure defining an arch wire groove 24 and undercuts 26. Bracket 22 also has a posterior surface 28 which confronts, and via which the bracket is releasably held in place on, a confronted surface of a tooth of model 20.

The procedure comprises creating model 20 and then mounting orthodontic brackets 22 such that each is releasably held in place at a desired surface location on a tooth of the model. Posterior surface 28 and the confronted surface of the tooth form an interface between the bracket and the model. While the drawings illustrate an example of applying brackets only to labial tooth surfaces, other examples (not illustrated) may involve applying brackets to lingual surfaces only or to both lingual and labial surfaces.

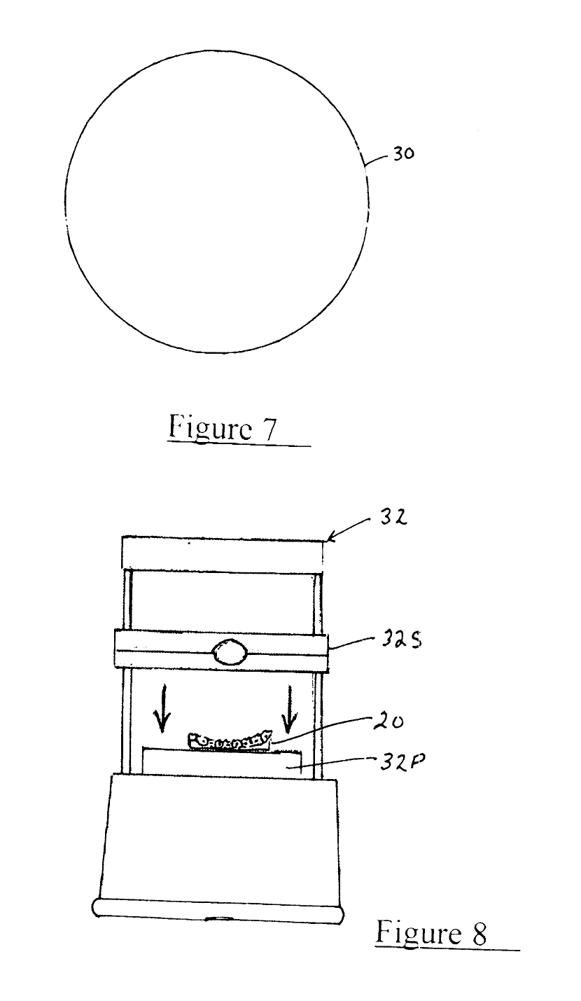

Next as shown in FIG. 6, a sheet 30, which is both formable and liquid-soluble and is suitable for use in an intra-oral environment, has a nominally flat shape which, when properly placed over a sufficient portion of each orthodontic bracket 22 and a sufficient portion of the corresponding tooth, enables sheet 30 to be subsequently formed to a shape which will dimensionally capture each bracket 22 and the corresponding tooth and will hold each bracket in the position at which it is being releasably held. The initial size and shape of sheet 30 depend on various factors. Besides the size of the model to which sheet 30 is to be applied, the sheet's size and shape may be a function of a particular machine which is used to form the sheet to its formed shape which captures and holds the brackets on the teeth. FIGS. 6 and 7 show an example of sheet 30 having uniform thickness and an initial circular shape. Another example would be a sheet having a square shape.

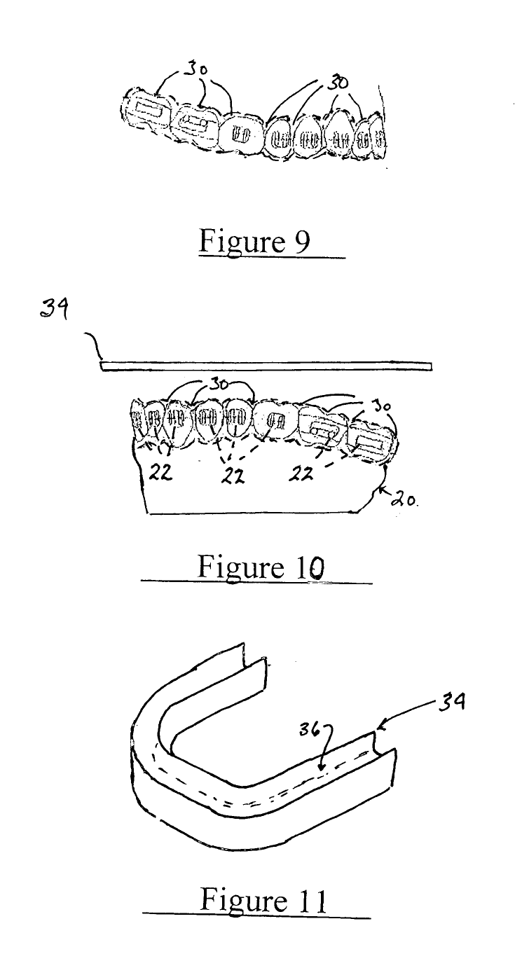

An example of a machine which can be used to form sheet 30 to formed shape for dimensionally capturing brackets 22 on model 20 and holding them in place is a thermoforming machine 32 shown in FIG. 8. The formed shape is depicted by the shaded area in FIG. 9 which by way of example captures the entirety of each bracket 22.

Thermoforming machine 32 comprises a platen 32P on which model 20 is placed with the teeth pointed upward. A slide 32S overlies platen 32P and functions to hold a circular sheet 30 which has not yet been formed. Slide 32S moves downward to place sheet 30 over model 20, and after placement, to heat sheet 30 just enough to cause it to form around the teeth of model 20 and orthodontic brackets 22, thereby capturing the brackets and holding them in place on the teeth. Some of the material of sheet 30 may form in undercuts 26 and/or arch wire groove 24. While the size of sheet 30 is large enough to capture and hold all brackets, excess material around the perimeter of the formed sheet may be cut away to leave the formed shape as shown in FIG. 9.

Next, a support tray 34, shown by itself in FIG. 11, is created by a step shown in FIG. 10. A sheet of material 34 from which the support tray is formed is placed in slide 32S and the slide is moved to place sheet 34 over and against formed sheet 30. Slide 32S heats the sheet to form the support tray in situ on model 20 in covering relation to at least a portion of formed sheet 30. Support tray 34 has a nominal thickness greater than that of sheet 30 and supports formed sheet 30 by its channel 36 fitting closely to the sheet but without intruding into arch wire grooves 24 and undercuts 26 in a way which would interfere with or prevent the tray from being separated from, formed sheet 30 after brackets 22 have been bonded to teeth of a patient's arch. Support tray 34 does have some flexibility which enables it to be separated from formed sheet 30 after brackets 22 have been bonded to teeth of a patient's arch. Depending on the location of a bracket on a tooth, support tray 34 may be formed to completely cover the portion of formed sheet 30 holding a bracket, to partially cover the portion of formed sheet 30 holding a bracket, or to leave the portion of formed sheet 30 holding a bracket uncovered.

After the step of FIG. 10, support tray 34 and formed sheet 30 are removed from model 20. Because orthodontic brackets 22 are held captured in position by formed sheet 30, they separate from model 20 with sheet 30 and support tray 34.

Support tray 34 is then used to fit brackets 22 to a patient's dental arch by placing surface 28 of each bracket 22 against a confronted surface of the patient's dental arch, after which each bracket is bonded to a tooth of the arch.

Support tray 34 is then removed from formed sheet 30, and the formed sheet is dissolved by applying dissolving liquid to it. The material of formed sheet 30 comprises a starch which can be dissolved in water. A 3.0 mil (0.003 inch) thickness for a starch sheet 30 is suitable and somewhat thicker sheets up to about 5.0 mil may perform satisfactorily. Various materials are suitable for support tray 34. They include polyvinyl chloride (PVC) and similar synthetics. While their thicknesses are typically greater than that of sheet 30 (30 mils is an example of a suitable thickness for PVC), they should be just thick enough to provide proper support and release from formed sheet 30.

While thermoforming is a suitable forming process, other forming processes, such as pressure-forming and vacuum-forming, are potentially suitable, and individual processes such as those three may be used in various combinations.

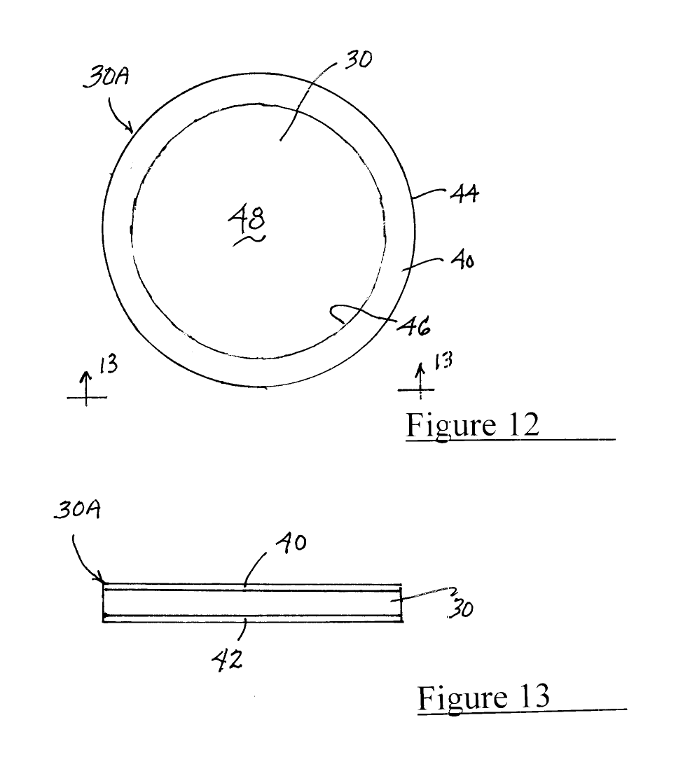

FIGS. 12 and 13 illustrate use of sheet 30 as an element of a sheet assembly 30A which comprises two further elements, namely an upper stiffener element 40 and a lower stiffener element 42, each of which is stiffer than sheet 30. Sheet 30 can be any material which is both formable and liquid-soluble and which is suitable for use in an intra-oral environment. When the selected material for sheet 30 is starch, the sheet's thickness is preferably not greater than 5.0 mil as mentioned above, and because of the presence of stiffener elements 40, 42, the thickness can be significantly less than 5.0 mil.

Stiffener elements 40, 42 are applied to respective upper and lower faces of sheet 30 and held fast on sheet 30 in any suitably appropriate way, such as adhesive. Each stiffener element is an annulus having a circular outer perimeter 44 and a circular inner perimeter 46. Outer perimeter 44 of each stiffener element is congruent with the circular outer perimeter of sheet 30, and inner perimeter 46 of each sheet surrounds a central circular uncovered zone 48 of sheet 30. The stiffener elements are dimensionally identical. In that way, stiffener elements 40, 42 sandwich an identical annulus of the outer perimeter margin of sheet 30 between themselves. When sheet assembly 30A is placed in a thermoforming machine which also has a vacuum forming capability and the machine is operated, zone 48 is heated and vacuum is applied to the heated zone to draw it onto a full or partial model of a dental arch which has been placed on the platen of the machine and contains at least one dental element on a tooth of the model. After forming of sheet 30, the perimeter margin of sheet assembly 30A containing stiffener elements 40, 42 is severed and removed from the remainder of the sheet.

The thicknesses of stiffener elements 40, 42 are essentially a function of the stiffener elements' materials. Although FIG. 13 shows the thicknesses and materials of stiffener elements 40, 42 to be the same in this example, one stiffener element could have thickness and/or material different from that of the other. Likewise, the thickness of a stiffener element may be greater than, equal to, or less than that of sheet 30. Examples of materials for the stiffener elements comprise vinyl and Mylar. Certain plastics may also be used.

The presence of stiffener elements 40, 42 facilitates handling of sheet 30 during placement of sheet assembly 30A in any type of forming machine. Their presence can also improve sealing of the perimeter margin of sheet 30 to platen and slide of a forming machine which has the capability of forming the sheet by vacuum-forming and/or pressure-forming in comparison to a sheet lacking the stiffener elements. That is because the respective stiffener elements, rather than sheet 30, are sealing to the machine's slide and its platen during forming of zone 48 while the slide and platen are forcing the stiffener elements toward each other and squeezing the perimeter margin of sheet 30 between them.

While FIGS. 12 and 13 represent a preferred embodiment because stiffener elements 40, 42 are disposed on opposite faces of sheet 30 and extend endlessly around the entire perimeter margin of the sheet, other embodiments may have only a single stiffener element on one side.

While the specific example shown in the drawings involves applying orthodontic brackets to teeth of a dental arch preparatory to bonding them to the teeth, the disclosed processes and devices are generic to the application of any of various dental treatment devices to a dental arch which requires locating a device on a person's arch in correspondence with a position at which the device has been placed on a model of the person's arch preparatory to securing the device to the person's arch. An example of a dental treatment device which can be placed other than on a tooth by using the disclosed process is a post for a replacement tooth which is placed in a person's gum tissue.

What is claimed is:

1. A procedure comprising:
creating a model of at least a portion of a patient's dental arch;
releasably holding a dental treatment element at a desired surface location on the model via an interface which interfaces mutually confronting surfaces of the dental treatment element and the model;
placing a starch sheet, which is both formable and liquid-soluble and has a nominal thickness not greater than 5.0 mil., in covering relation to a sufficient portion of the dental treatment element and a sufficient portion of the model to enable the starch sheet to be formed to a shape which will dimensionally capture the dental treatment element and hold it in the position at which it is releasably held on the model;
forming the starch sheet to a shape which dimensionally captures the dental treatment element and holds it in the position at which it is releasably held on the model; and
separably fitting a support tray, which is releasable from the formed starch sheet, to the model in covering relation to the formed starch sheet.

2. A procedure as set forth in claim 1 in which the step of separably fitting a support tray to the model in covering relation to the formed starch sheet comprises forming the support tray in situ on the model in covering relation to the formed starch sheet.

3. A procedure as set forth in claim 2 further comprising removing the dental treatment element, the formed starch sheet, and the support tray from the model and applying them to a patient's dental arch to place the one of the mutually confronting surfaces belonging to the dental treatment element in confronting relation to a confronted surface of the patient's dental arch, and then bonding the one confronting surface belonging to the dental treatment element to the confronted surface of the patient's dental arch.

4. A procedure as set forth in claim 3 further comprising removing the support tray from the formed starch sheet, and dissolving the formed starch sheet by applying dissolving liquid to the formed starch sheet.

5. A procedure as set forth in claim 1 in which the step of releasably holding a dental treatment element at a desired surface location on the model via an interface which interfaces mutually confronting surfaces of the dental treatment element and the model comprises releasably holding a dental treatment element at a desired surface location on a tooth of the model via an interface which interfaces mutually confronting surfaces of the dental treatment element and the tooth of the model.

6. A procedure comprising:
creating a model of at least a portion of a patient's dental arch;
releasably holding at least one dental treatment element at a desired surface location on the model via an interface which interfaces mutually confronting surfaces of the dental treatment element and the model;
placing a sheet assembly comprising a sheet, which is both formable and liquid-soluble and which has a central zone surrounded by a perimeter margin, and at least one stiffener element disposed on the perimeter margin of the sheet, to dispose the central zone of the sheet in covering relation to a sufficient portion of the at least one dental treatment element and a sufficient portion of the model to enable the sheet to be formed to a shape which dimensionally captures the at least one dental treatment element and holds it in the position at which it is held on the model; and
forming the central zone of the sheet to a shape which dimensionally captures the at least one dental treatment element and holds it in the position at which it is held on the model.

7. A procedure as set forth in claim 6 further comprising severing the perimeter margin of the sheet, including the at least one stiffener element, from the central zone of the sheet after the central zone has been formed to capture the at least one dental treatment model.

8. A procedure as set forth in claim 7 in which the step of forming the central zone of the sheet to a shape which dimensionally captures the at least one dental treatment bracket and holds it in the position at which it is held on the model comprises at least one of vacuum-forming and pressure-forming the central zone of the sheet.

9. A procedure as set forth in claim 8 further comprising, separably fitting a support tray, which is releasable from the sheet, to the central zone of the sheet after forming of the central zone.

10. A procedure as set forth in claim 9 in which the step of separably fitting a support tray to the central zone of the sheet comprises forming the support tray in situ in covering relation to the central zone of the sheet.

11. A procedure as set forth in claim 10 further comprising removing the at least one dental treatment element, the central zone of the sheet, and the support tray from the model and applying them to a patient's dental arch to place the one of the mutually confronting surfaces belonging to the at least one dental treatment element in confronting relation to a confronted surface of the patient's dental arch, bonding the one confronting surface belonging to the at least one dental treatment element to the confronted surface of the patient's dental arch, separating the support tray from the central zone of the sheet, and dissolving the central zone of the sheet by applying dissolving liquid to the central zone of the sheet.

12. A sheet assembly for use in fabricating an impression of at least a portion of a patient's dental arch while also capturing and holding a dental treatment device which is being releasably held on a model of at least a portion of a patient's dental arch, the sheet assembly comprising:
a sheet which is suitable for use in an intra-oral environment and is both formable and liquid-soluble, the sheet having a perimeter margin;
at least one stiffener element disposed and held on the sheet's perimeter margin, the at least one stiffener element having stiffness greater than that of the sheet; and
the sheet comprising a central zone uncovered by the at least one stiffener element.

13. A sheet assembly as set forth in claim 12 in which the at least one stiffener element extends endlessly around the entire perimeter margin of the sheet.

14. A sheet assembly as set forth in claim 13 in which the at least one stiffener element comprises an upper stiffener element disposed on an upper face of the sheet and a lower stiffener element disposed on a lower face of the sheet, each stiffener element extending endlessly around the entire perimeter margin and cooperating with the other stiffener element to sandwich the entire perimeter margin of the sheet between them.

15. A sheet assembly as set forth in claim 14 in which the upper stiffener element and the lower stiffener element are dimensionally identical and are congruent with an edge of the perimeter margin of the sheet.

16. A sheet assembly as set forth in claim 15 in which the sheet comprises a thickness not greater than 5.0 mil.
